(19) United States
(12) Patent Application Publication
(10) Pub. No.: US 2006/0006584 A1
(43) Pub. Date: Jan. 12, 2006

(54) Method for producing a container having at least one vent opening

(76) Inventor: Roland Kneer, Farchant (DE)

Correspondence Address: GREER, BURNS & CRAIN, 300 S WACKER DR, 25TH FLOOR, CHICAGO, IL, 60606, US

(21) Appl. No.: 10/536,944

(22) PCT Filed: Nov. 25, 2003
(86) PCT No.: PCT/DE03/03909

§ 371 Date: May 27, 2005

(30) Foreign Application Priority Data
Nov. 30, 2002 (DE) 102 56 015.3

(51) Int. Cl. B29C 49/50

(52) U.S. Cl. 264/454; 264/540; 264/154

(57) ABSTRACT

The receptacle consists of a stiff outer receptacle and an easily deformable inner bag resting thereon and is produced in a coextrusion-type blow molding process. The outer receptacle contains at least one pressure compensating opening through which air enters between the outer receptacle and the inner bag whenever the contents of the receptacle is discharged. The pressure compensating opening is formed by an oscillating tool which cuts a slit-shaped recess out of the wall of the outer receptacle without the inner bag being impaired by the oscillating tool.

The present invention relates to a method for producing a receptacle which consists of a substantially stiff outer receptacle and an easily deformable inner bag which are made from respectively different thermoplastic materials that do not form a welded joint with one another, according to the preamble of patent claim 1.

In the method of the type in question, a parison which includes the flexible tubes forming the inner bag and the outer receptacle is first co-extruded and then inflated in a blow mold to obtain the finished receptacle, with excess material being squeezed off on the bottom of the receptacle to be produced. The bottom seam of the inner bag is thereby tightly sealed or welded, and said welded bottom seam is clamped by the special shape of the bottom-sided squeeze portion of the blow mold in the welded bottom seam of the outer receptacle, whereby the inner bag is axially held on the bottom of the outer receptacle.

Such a configuration of the welded bottom seam of the outer receptacle and the clamping of the bottom-sided weld seam of the inner bag are described in DE 41 39 555 C2.

For discharging the receptacle contents a receptacle of the type in question is provided with a pump. The receptacle contents, however, can also be discharged by squeezing the outer receptacle by hand, whereupon the receptacle will reassume its initial shape after pressure compensation has been carried out between the inner bag and the outer receptacle.

In the receptacle according to DE 41 39 555 C2, pressure compensation which is required due to the volume reduction of the inner bag entailed by the discharge of the receptacle contents is carried out through unwelded shoulder seams of the outer receptacle. This may entail problems when a pump is mounted. Furthermore, only receptacles with shoulder sections can be provided with such pressure compensating seams whereas this is not possible in so-called wide-necked containers in the described way.

DE 197 37 946 C2 discloses a method for producing a receptacle comprising at least one pressure compensating opening, wherein a knife which impinges at a flat angle on a curved circumferential section of the outer receptacle cuts away a chip from the outer wall, whereby an approximately elliptical or lenticular cutting surface is formed with a hole leading through the wall of the outer receptacle, Although the knife impinges on the inner bag after having penetrated through the wall of the outer receptacle, this takes place at such a flat angle that the inner bag will recede without any damage. In practice this method has turned out to be useful, but shows the drawback that a relatively large cutting surface is formed which might give a user the impression that the receptacle is damaged when the opening is not covered by a pump housing.

EP-A 0 759 399 discloses a method in which a tubular blade is pressed into the outer layer of the neck of a receptacle to perforate the outer layer.

U.S. Pat. No. 6,244,852 discloses a method in which a wall opening is formed by the measure that a cut or a notch is cut or punched into the wall of the outer receptacle, said cut or notch penetrating through the wall, except for a small residual wall section, the residual wall section being opened by applying a force. This is accomplished in that a knife blade is pivoted over such a radius that a cut is carried out through the wall of the outer receptacle in the shoulder area of the receptacle.

EP-A-0 182 094 discloses a method in which the pressure compensating opening of the outer receptacle is formed in that the bottom area of the receptacle is squeezed off such that an unwelded bottom seam is created on the outer receptacle.

It is the object of the present invention to provide a method with which the at least one pressure compensating opening can be formed in an easy way and is hardly noticed.

According to the invention this object is achieved by the features of patent claim 1.

Advantageous developments of the invention are characterized in the subclaims. According to the invention the at least one wall opening is formed by an oscillating tool. The oscillating tool may be attached at any desired place of the outer receptacle onto the wall thereof and, while preferably oscillating in a transverse direction, it is advanced through the wall, with material of the wall being removed in fine dust-like particles. The developing dust can be sucked off by a suitable vacuum means at the place of treatment. The oscillating tool preferably forms an elongated, possibly arcuate, slit in the wall of the outer receptacle, which slit may be so small that a user cursorily looking thereat will virtually not notice said slit. The width of the slit may e.g. be 2-3 mm.

The tool can also perform an oscillating rotary movement, i.e. oscillate at a high oscillation frequency alternatingly clockwise and counterclockwise, resulting in the formation of a circular hole in the wall.

The tool, which is preferably a saw blade provided with teeth or a tapering cutting disk, can e.g. oscillate at about 10,000 to 20,000 oscillations/minute, without the invention being limited thereto.

Other oscillating tools can also be used, e.g. a wire with a rough/uneven surface, a rod with a rough/uneven face, or a diamond-studded separating tool.

After having fully passed through the wall of the outer receptacle, the oscillating tool impinges on the inner bag. Surprisingly, it has been found that the inner bag is not injured or damaged by the oscillating tool although it gets into contact with the oscillating tool.

With the method of the invention the pressure compensating openings can easily be formed with very little time being spent thereon because neither the corresponding place(s) for forming the pressure compensating opening nor the cutting depth of the tool is critical. Moreover, oscillating tools are available at low costs,

According to a further suggestion of the invention the inner bag preferably consists of PE or a PE-based ionomer or a multi-layered material combination while the outer receptacle preferably consists of PET. With this material combination the adhesion of the inner bag to the outer receptacle is minimal, so that, in contrast to other material combinations, the inner bag need first not be removed from the outer receptacle by application of a vacuum after production of the finished receptacle before the inner bag is then given its initial shape again by introducing compressed air. When the above material combination according to the invention is used, the receptacle can be filled with receptacle liquid without previous detachment of the inner bag, and during the subsequent discharge of the receptacle contents the inner bag will smoothly detach from the outer receptacle.

Hence, the invention provides a simple and inexpensive method with which one or several pressure compensating openings, which are hardly noticed, can be formed on a receptacle of the above-mentioned type virtually at any place without the risk of damage to the inner bag.

Further details of the invention will become apparent from the following description and with reference to the drawing, in which:

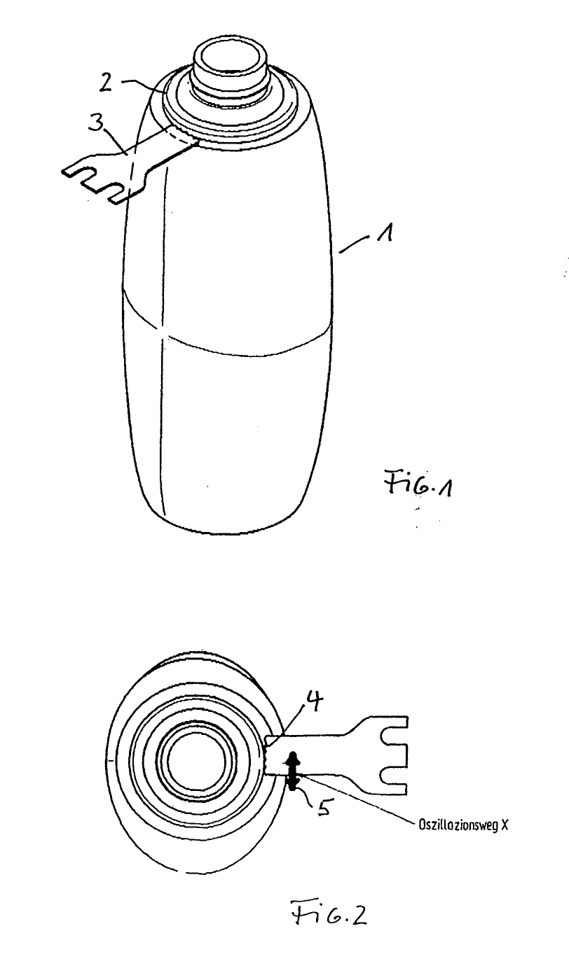

FIG. 1 is a perspective view of a receptacle in the case of which an oscillating tool is attached to the neck portion;

FIG. 2 is a top view on the assembly according to FIG. 1;

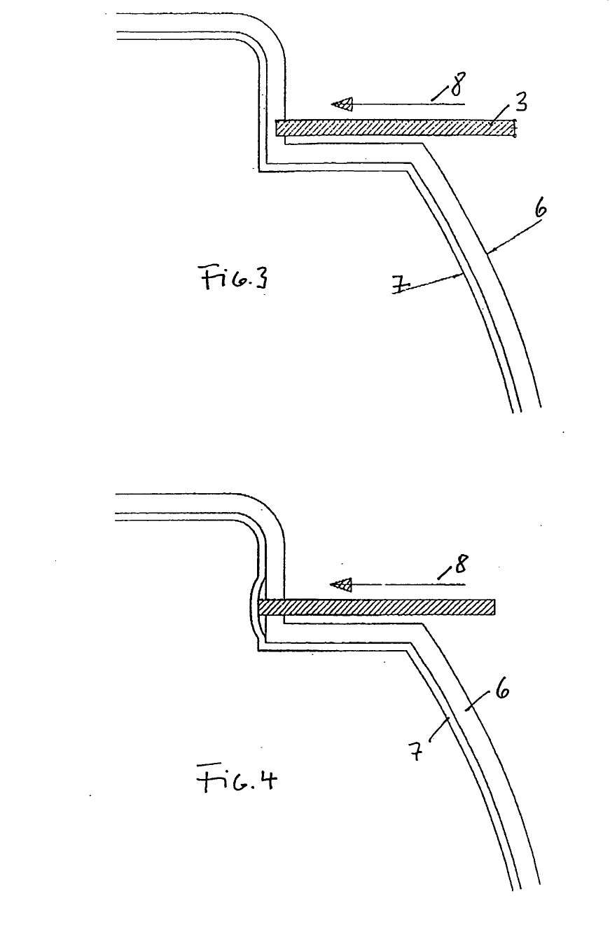

FIGS. 3 and 4 are schematic illustrations showing the advance movement of the oscillating tool for forming a pressure compensating opening.

FIG. 1 illustrates a slightly bulging receptacle 1 having a shoulder portion 2 to which an oscillating tool is attached in the form of a saw blade 3 with small teeth 4 at the front side. The saw blade 3 is laterally oscillated by an actuator (not shown), such lateral oscillations being illustrated in FIG. 2 by arrow 5.

As shown in FIGS. 3 and 5, the receptacle consists of a substantially stiff outer bottle 6 and an inner bag 7 resting thereon, which is made of a soft plastic material.

As schematically shown in FIGS. 3 and 4, the saw blade 3 is advanced in the direction of an arrow 8 through the wall of the outer bottle 6. After having passed through the wall of the outer bottle 6, in which process a slit-shaped opening is formed in the wall of the outer bottle 6, the saw blade impinges on the inner bag 7 which yields inwards without being damaged.

1. A method for producing a receptacle consisting of a substantially stiff outer receptacle and an easily deformable inner bag which are made from respectively different thermoplastic materials that do not form a welded joint with one another, said receptacle comprising a receptacle opening and at least one wall opening provided in the outer receptacle, through which pressure is compensated in the area between the inner bag and the outer receptacle, with a parison, which consists of at least two tubings, being coextruded and arranged between the opened halves of a blow mold, the blow mold being subsequently closed when said parison has reached the length required for producing said receptacle, excess material being squeezed off in the bottom area of the receptacle to be produced, and a web made of welded material of said outer receptacle being formed, in which web the welded bottom seam of the inner bag is clamped and held in axial direction, and said parison being inflated by a pressure medium for contact with the wall of the blow mold and removed from said blow mold,
said method for producing a receptacle comprising at least one wall opening being formed by a tool having an uneven surface which oscillates at a high oscillation frequency and removes wall material in dust-like particles.

2. The method according to claim 1, wherein said tool oscillates at about 10,000 to 20,000 oscillations/minute.

3. The method according to claim 1 wherein said tool is a saw blade provided with teeth or is a diamond-studded separating tool.

4. The method according to claim 1 wherein the wall opening has the shape of an elongated slit with parallel boundary walls or has the shape of an arc.

5. The method according to claim 2 wherein said tool is a saw blade provided with teeth or is a diamond-studded separating tool.

6. The method according to claim 2 wherein the wall opening has the shape of an elongated slit with parallel boundary walls or has the shape of an arc.

7. The method according to claim 3 wherein the wall opening has the shape of an elongated slit with parallel boundary walls or has the shape of an arc.
